(19) United States
(12) Patent Application Publication
(10) Pub. No.: US 2015/0030071 A1
(43) Pub. Date: Jan. 29, 2015

(54) MOTION VECTOR REUSE FOR ADAPTIVE BIT RATE STREAMING

(71) Applicant: BROADCOM CORPORATION, Irvine, CA (US)

(72) Inventor: Brian Allen HENG, Irvine, CA (US)

(73) Assignee: BROADCOM CORPORATION, Irvine, CA (US)

(21) Appl. No.: 13/950,209

(22) Filed: Jul. 24, 2013

(51) Int. Cl. H04N 19/51

(52) U.S. Cl. CPC H04N 19/00696
USPC 375/240.16

(57) ABSTRACT

A device for motion vector reuse for adaptive bit rate streaming may include a first encoder, a second encoder, and a network interface. The first encoder may be configured to perform motion estimation on a video content item to generate motion vectors for the video content item and to encode the video content item using the generated motion vectors and based at least in part on a first adaptive bit rate (ABR) profile to generate a first encoded stream. The second encoder may be configured to encode the video content item using the motion vectors generated by the first encoder and based at least in part on a second ABR profile to generate a second encoded stream. The network interface may be configured to initiate transmission of segments of the first and second encoded streams in response to requests therefor.

### TECHNICAL FIELD

The present description relates generally to motion vector reuse, and more particularly, but not exclusively, to motion vector reuse for adaptive bit rate streaming.

### BACKGROUND

In an adaptive bit rate (ABR) streaming system, a content item is encoded by an adaptive bit rate (ABR) server into multiple streams of varying bit rates with each stream being divided into sequential segments of a given duration (e.g. 2-10 seconds). The streams may also vary in other encoding characteristics, such as levels of compression, frame rates, resolutions, codecs, etc. The ABR server transmits a manifest file to client devices that lists the segments of the content item, the different bit rates (and/or other encoding characteristics) at which the segments have been encoded, and network identifiers for accessing the segments, e.g. uniform resource locators (URLs). The different bit rates (and/or other encoding characteristics) at which the segments have been encoded may be referred to as different profiles of the content item, or different adaptive bit rate (ABR) profiles of the content item. A client device may retrieve each segment at the bit rate (and/or other encoding characteristics) that is appropriate for the client device, e.g. based on network bandwidth conditions and device capabilities that are determinable by the client device. In this manner, the client device may adaptively retrieve segments that are encoded at different bit rates in accordance with changing network bandwidth conditions, and the client device may then seamlessly switch, at the end of each segment, to a segment that is encoded at a different bit rate. However, in one or more implementations, the number of profiles that an adaptive bit rate server can provide to the client devices for a given content item may be limited by the processing and/or encoding resources that are available to the adaptive bit rate server.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which motion vector reuse for adaptive bit rate streaming may be implemented in accordance with one or more implementations.

FIG. 2 illustrates an example network environment in which motion vector reuse for adaptive bit rate streaming may be implemented in accordance with one or more implementations.

FIG. 3 illustrates an example adaptive bit rate server that may implement motion vector reuse for adaptive bit rate streaming in accordance with one or more implementations.

FIG. 4 illustrates an example adaptive bit rate server that may implement motion vector reuse for adaptive bit rate streaming in accordance with one or more implementations.

FIG. 5 illustrates an example adaptive bit rate server that may implement motion vector reuse for adaptive bit rate streaming in accordance with one or more implementations.

FIG. 6 illustrates an example network environment in which motion vector reuse for adaptive bit rate streaming may be implemented in accordance with one or more implementations.

FIG. 7 illustrates a flow diagram of an example process of motion vector reuse for adaptive bit rate streaming in accordance with one or more implementations.

FIG. 8 illustrates spatial motion vector scaling for motion vector reuse in accordance with one or more implementations.

FIG. 9 illustrates temporal motion vector scaling for motion vector reuse in accordance with one or more implementations.

FIG. 10 illustrates motion vector aggregation for motion vector reuse in accordance with one or more implementations.

FIG. 11 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

In the subject system for motion vector reuse for adaptive bit rate streaming, an ABR server may perform motion estimation to generate motion vectors for encoding a content item in accordance with one ABR profile and the ABR server may reuse the motion vectors for encoding the content item in accordance with other ABR profiles, e.g. to generate streams of varying bit rates and/or varying in other encoding characteristics (e.g. different levels of compression, different frame rates, different video formats, etc.) for the content item. Since each of the streams includes a different encoding of the same original content item, the motion vectors generated for encoding one stream, e.g. the highest quality stream, may be reused to encode the other streams. Thus, only the back-end encoding steps, e.g. quantization, transform, entropy coding, deblocking filter, etc., would be performed individually for each stream. Since motion estimation is generally the most computationally expensive task of the encoding process, the processing and/or encoding resources of the ABR server that are required to generate the streams may be significantly reduced.

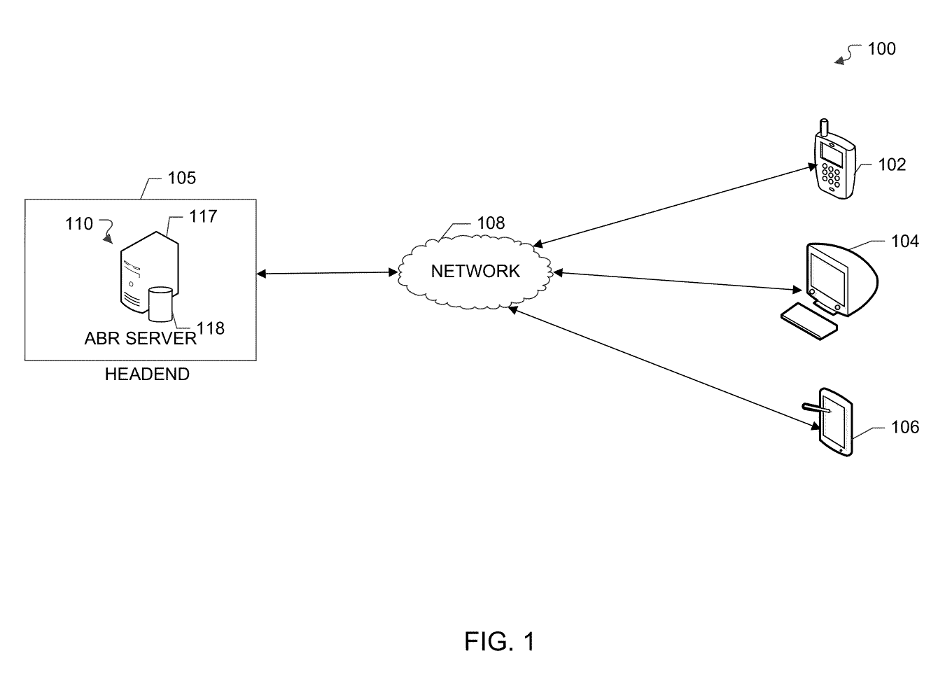

FIG. 1 illustrates an example network environment 100 in which motion vector reuse for adaptive bit rate streaming may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 100 includes a headend 105, a network 108, and electronic devices 102, 104, 106. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

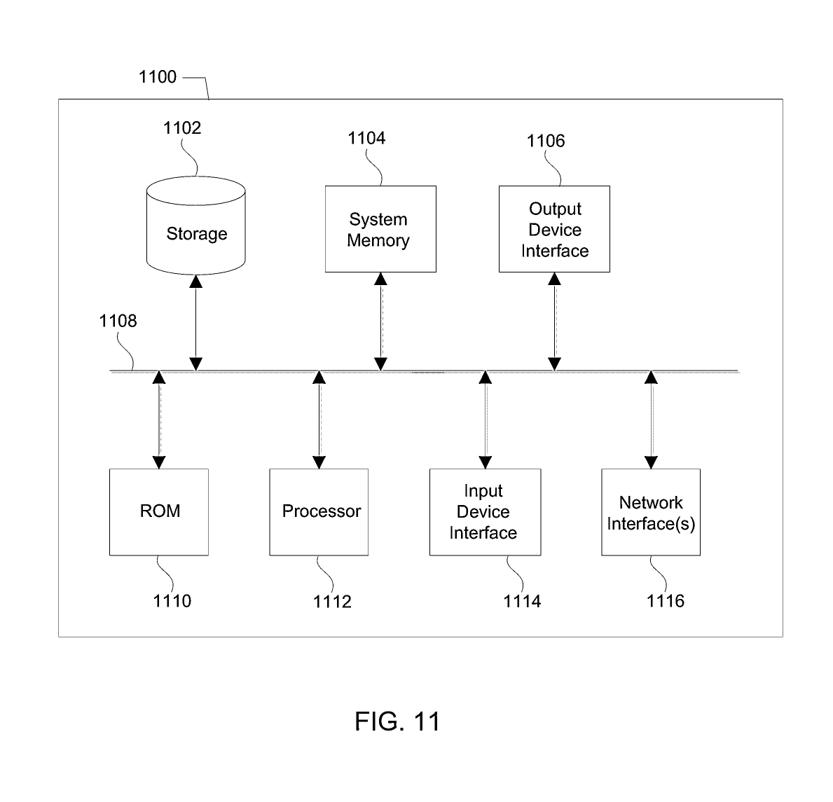

The electronic devices 102, 104, 106 can be computing devices such as laptop or desktop computers, smartphones, personal digital assistants (“PDAs”), portable media players, set-top boxes, tablet computers, televisions or other displays with one or more processors coupled thereto and/or embedded therein, or other appropriate computing devices that can be used for adaptive bit rate streaming, and rendering, of multimedia content and/or can be coupled to such a device. In the example of FIG. 1, the electronic device 102 is depicted as a smart phone, the electronic device 104 is depicted as a desktop computer, and the electronic device 106 is depicted as a tablet device. In one or more implementations, any of the electronic devices 102, 104, 106 may be referred to as a user device The electronic devices 102, 104, 106, may be, or may include one or more components of, the electronic system discussed below with respect to FIG. 11.

The headend 105 may include one or more devices, such as network devices, transmitters, receivers, etc., and/or servers, such as the ABR server 110, that are part of a content delivery network (CDN) that coordinates the delivery of content items, such as television programs, movies, audio programs, or generally any content items. The content delivery network may deliver the content items to the electronic devices 102, 104, 106, e.g. via the network 108.

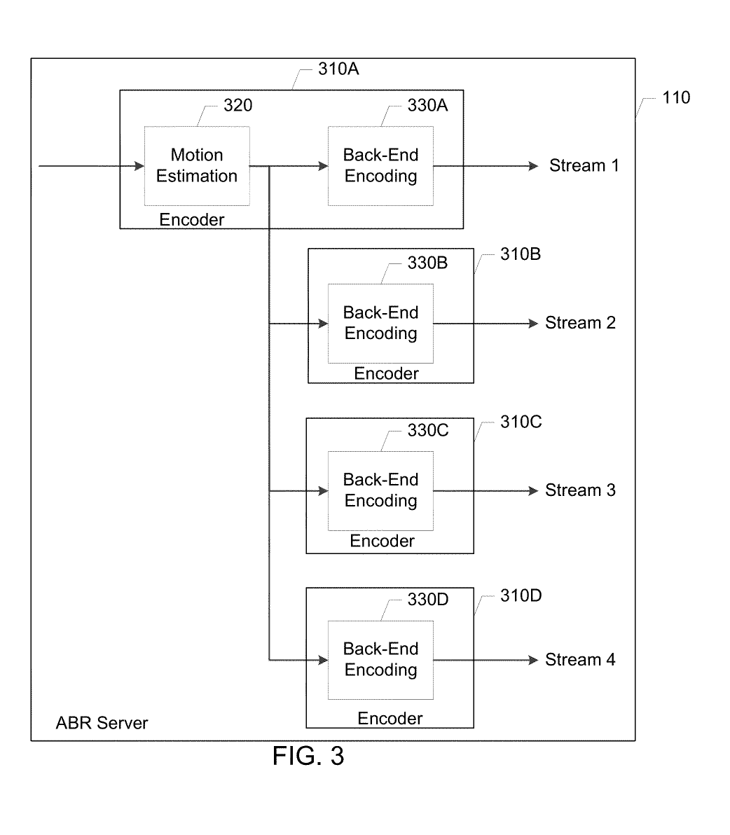

The ABR server 110 may include, or may be coupled to, one or more processing devices 117 and/or a data store 118. The one or more processing devices 117 execute computer instructions stored in the data store 118, for example, to distribute content items via ABR streaming. The data store 118 may store the computer instructions on a non-transitory computer-readable medium. The data store 118 may further store one or more content items that are ABR streamed by the ABR server 110. In one or more implementations, the ABR server 110 may be a single computing device such as a computer server. Alternatively, the ABR server 110 may represent multiple computing devices that are working together to perform the actions of a server computer (such as a cloud of computers and/or a distributed system). The ABR server 110 may be coupled with various databases, storage services, or other computing devices, that may be collocated with the ABR server 110 or may be disparately located from the ABR server 110. Example ABR servers 110 are discussed further below with respect to FIGS. 3-5. Furthermore, the ABR server 110 may be, or may include one or more components of, the electronic system discussed below with respect to FIG. 11.

The ABR server 110 may provide ABR streaming for content items delivered by the CDN. For example, the ABR server 110 may encode a content item into multiple streams having different encoding characteristics, such as different bit rates, different frame rates, different resolutions, different codecs, or generally any encoding characteristic. In one or more implementations, the encoding characteristics of a given stream may be referred to as the adaptive bit rate (ABR) profile of the stream. The ABR server 110 divides each stream into sequential segments of a given duration (e.g. 2-10 seconds). The ABR server 110 generates a manifest file that lists the available segments, the different ABR profiles of the segments, and network identifiers for accessing each segment, such as a uniform resource locator (URL). The ABR server 110 transmits the manifest file to the electronic devices 102, 104, 106. The electronic devices 102, 104, 106 may retrieve segments of the content item from the ABR sever 110 at the available bit rates that are appropriate for the electronic devices 102, 104, 106, e.g. based on the capabilities of the electronic devices 102, 104, 106 and/or the network bandwidth conditions between the electronic devices 102, 104, 106 and the ABR server 110.

Since the ABR server 110 is encoding the same content item into multiple different streams, the ABR server 110 may perform motion estimation on the content item to generate motion vectors for encoding one of the streams, and the ABR server 110 may reuse the motion vectors, or modified versions thereof, for encoding the other streams. Thus, only the ABR server 110 only performs the back-end encoding steps, e.g. quantization, transform, entropy coding, deblocking filter, etc., individually for the other streams.

In one or more implementations, the motion estimation process performed by the ABR server 110 may be separated into multiple stages, such as a coarse motion estimation stage and a fine motion estimation stage. The coarse motion estimation stage may search a wide range of pixels to generate coarse motion vectors that provide a coarse estimate of the motion. The fine motion estimation stage may then search a region around the coarse motion vectors to refine the coarse motion vectors. For example, the coarse motion estimate might find vectors of full-pixel accuracy, while the fine motion estimation stage may refine those vectors to half-pixel or quarter-pixel accuracy. Since the coarse motion estimation stage searches over a wider range of pixels than the fine motion estimation stage, the coarse motion estimation stage may require more processing/encoding resources than the fine motion estimation stage. The ABR server 110 may generate coarse motion vectors for one of the streams and may reuse the coarse motion vectors to perform individual fine motion estimation for each stream. Thus, the more costly coarse motion estimation stage is only performed once, thereby conserving processing and/or encoding resources of the ABR server 110.

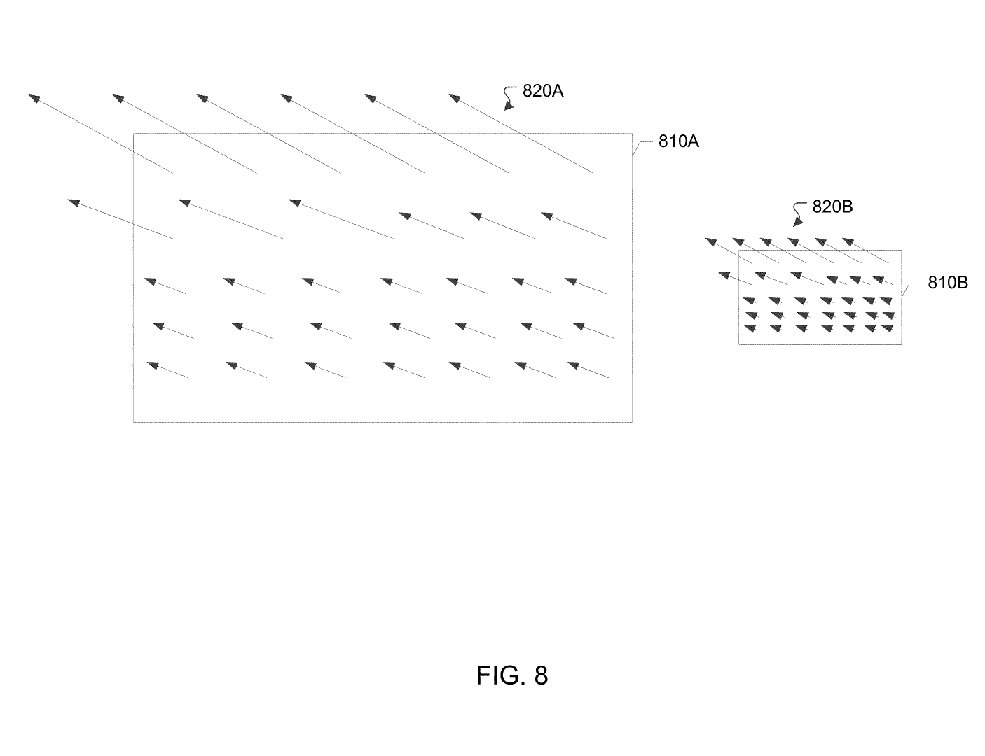

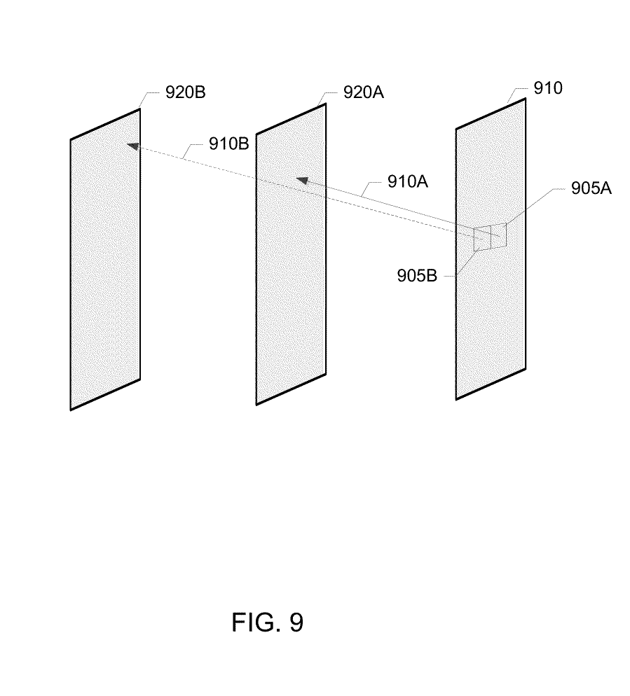

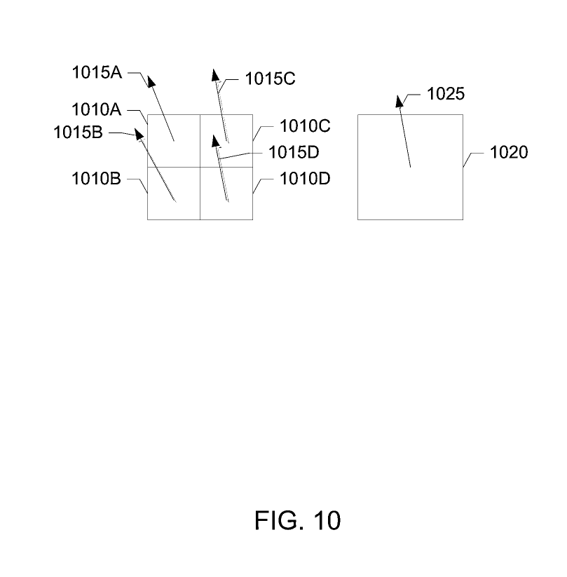

Since the encoding characteristics may vary across the encoded streams, e.g. different resolutions, different frame rates, different codecs, etc., the ABR server 110 may need to modify the motion vectors in order to reuse the motion vectors to encode one or more of the streams. For example, the motion vectors may be spatially scaled to account for changes in resolution, e.g. the motion vectors may be scaled proportionally to the resolution change. An example of spatial motion vector scaling is discussed further below with respect to FIG. 8. The motion vectors may be temporally scaled to account for changes in frame rates and/or codecs. For example, if motion estimation is performed on a stream that is encoded at 60 frames per second, the motion vectors may need to be temporally scaled in order to be reused for a stream that is encoded at 30 frames per second. An example of temporal motion vector scaling is discussed further below with respect to FIG. 9. In one or more implementations, the available motion vector sizes may differ from codec to codec. Thus, if the generated motion vectors are too small to be used by a particular codec for encoding a given stream, the motion vectors may be aggregated, e.g. based on an average vector, a median vector, etc., to generate larger sized motion vectors that can be used for encoding the given stream. An example of motion vector aggregation is discussed further below with respect to FIG. 10. Conversely, if the generated motion vectors are too large to be reused by a particular codec for a given stream, the motion vectors may be duplicated for across smaller regions. For example, a 64×64 vector in High Efficiency Video Coding (HEVC) can be duplicated for use in all of the corresponding 16×16 macroblock positions of an MPEG-2 sequence.

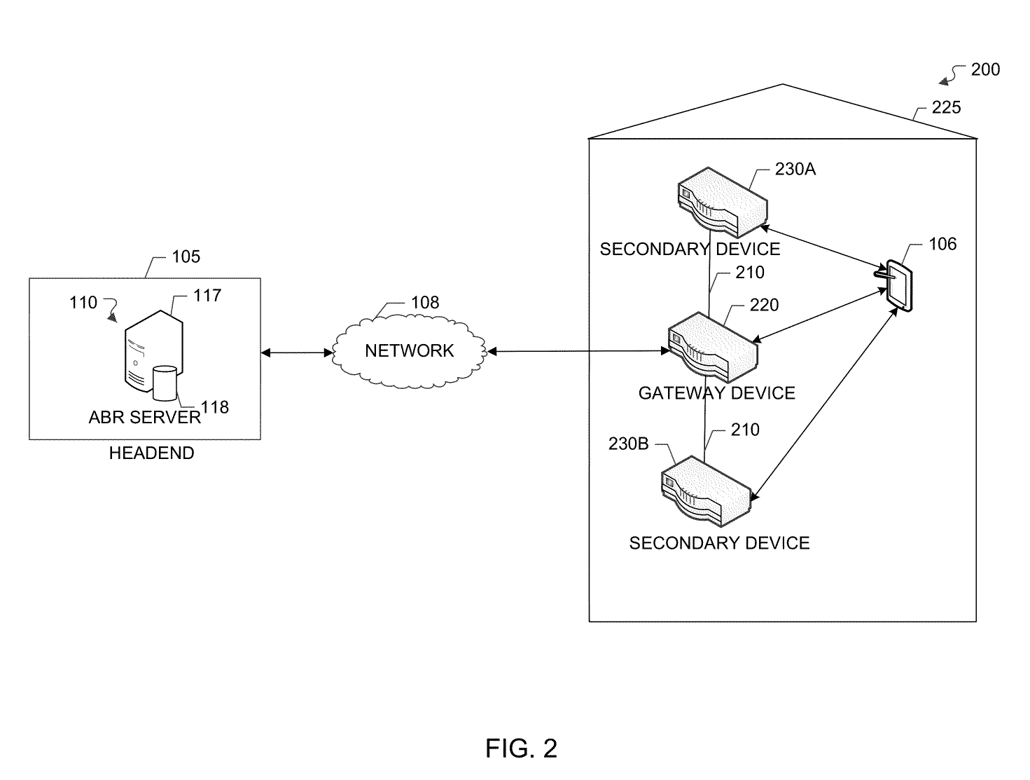

FIG. 2 illustrates an example network environment 200 in which motion vector reuse for adaptive bit rate streaming may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 200 includes the headend 105, the network 108, and a unit 225. The unit 225 includes a gateway device 220, secondary devices 230A-B, a transmission network 210, and the electronic device 106. The unit 225 may further include additional electronic devices, such as the electronic devices 102, 104 of FIG. 1. The unit 225 may be a building, a dwelling unit, a house, an office, or any generally structure. For explanatory purposes, the unit 225 is illustrated as being a standalone building; however, the unit 225 may be within an apartment building or an office building.

The gateway device 220 may be coupled to the secondary devices 230A-B via the transmission network 210. The transmission network 210 may include one or more transmission lines, such as coaxial transmission lines. The gateway device 220 and/or the secondary devices 230A-B may include a network processor or a network device, such as a switch or a router, that is configured to couple the electronic device 106 to the headend 105. The gateway device 220 and/or the secondary devices 230A-B may include local area network interfaces, such as wired interfaces and/or wireless access points, for communicating with the electronic device 106. In one or more implementations, the gateway device 220 and/or the secondary devices 230A-B may be, or may include, a set-top box, e.g. a device that is coupled to a display, such as a television, and is capable of rendering multimedia content on the display.

At any given time, the gateway device 220 may select to retrieve a segment of a content item from the ABR server 110 of the headend 105, e.g. based on network bandwidth conditions between the gateway device 220 and the ABR server 110 and/or based on the capabilities of the gateway device 220, such as the codecs that are decodable by the gateway device 220. In addition to retrieving segments of ABR streams from the ABR server 110, the gateway device 220 may receive streams from the headend 105 that include content items, such as television programs, movies, or generally any content items.

The gateway device 220 may act as an ABR intermediary, or an ABR proxy device, between the ABR server 110 and the electronic device 106. For example, the gateway device 220 may retrieve segments of a content item at an appropriate bit rate that is determined based on the network bandwidth conditions between the gateway device 220 and the ABR server 110. The gateway device 220 may then transcode the segments in accordance with one or more adaptive bit rate profiles, e.g. by reusing motion vectors as discussed herein. The gateway device 220 may generate a manifest file that lists the different transcoded versions of the segments, in addition to the originally retrieved segments. The gateway device 220 may transmit the manifest file to the electronic device 106. The electronic device 106 may retrieve segments from the gateway device 220 at the available bit rates that are appropriate for the electronic device 106, e.g. based on the capabilities of the electronic device 106 and/or the determinable network bandwidth conditions between the electronic device 106 and the gateway device 220. Thus, the gateway device 220 may include a local ABR server that performs local ABR streaming functions for the electronic device 106.

In one or more implementations, the gateway device 220 may utilize encoders located in the secondary devices 230A-B in order to provide access to additional adaptive bit rate profiles to the electronic device 106. For example, the secondary devices 230A-B may be set-top boxes (STBs) that includes one or more encoders that are located in secondary rooms of the unit 225, such as bedrooms, and that includes a wireless access point for communicating with the electronic device 106. The gateway device 220 retrieves segments of a content item from the ABR server 110, e.g. based on network bandwidth conditions between the gateway device 220 and the ABR server 110. The gateway device 220 performs motion estimation on the segments to generate motion vectors, and the gateway device 220 transmits the segments (before transcoding) and the motion vectors to the secondary devices 230A-B along with an indication of one or more encodings to be performed by the secondary devices 230A-B. The secondary devices 230A-B may transcode the received segments, using the received motion vectors, and in accordance with the transcoding indicated by the gateway device 220.

In one or more implementations, the ABR server 110 may insert the motion vectors corresponding to each frame into the original video stream of the content item as picture level user data and may transmit the video stream of the content item, including the inserted motion vectors, to the encoding devices. Alternatively, or in addition, the ABR server 110 may packetize the motion vectors separately from the content item. The motion vector packets may include presentation time stamp (PTS) values that correspond to the PTS values of the original content item. The secondary devices 230A-B may synchronize the motion vector packets with the original content item based on the PTS values.

The gateway device 220 generates and transmits a manifest file to the electronic device 106 that includes the additional profiles for which the secondary devices 230A-B are performing the transcoding. The electronic device 106 may retrieve the segments directly from the secondary devices 230A-B, e.g. via wireless access points of the secondary devices 230A-B when such a connection is available, or through the gateway device 220 when direct connections to the secondary devices 230A-B are not available. For example, the secondary devices 230A-B may transmit the transcoded segments back to the gateway device 220 for transmission to the electronic device 106.

FIG. 3 illustrates an example adaptive bit rate (ABR) server 110 that may implement motion vector reuse for adaptive bit rate streaming in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The adaptive bit rate server 110 includes encoders 310A-D. The encoders each include back-end encoding blocks 330A-D and the encoder 310A includes a motion estimation block 320. The blocks 330A-D may be, or may include, suitable logic, circuitry, interfaces, memory, processors, and/or code that enables one or more back-end encoding steps, such as e.g. quantization, transform, entropy coding, deblocking filter. The motion estimation block 320 may be, or may include, suitable logic, circuitry, interfaces, memory, processors, and/or code that enables motion estimation for a video stream.

In operation, the ABR server 110 obtains a video stream corresponding to a video content item, e.g. from the headend 105. The ABR server 110 determines different ABR profiles, e.g. different bit rates (and/or other encoding characteristics) for encoding the video stream, and the ABR server 110 may configure the encoders 310A-D based at least in part on the different ABR profiles. The motion estimation block 320 of the encoder 310A performs motion estimation on frames of the video stream to generate motion vectors. Although the encoder 310A is illustrated as including a motion estimation block 320, any of the other encoders 310B-D may also include a motion estimation block 320 that may perform the motion estimation. In one or more implementations, the encoder 310A that is associated with the highest quality ABR profile, e.g. the highest bit rate, may perform the motion estimation. The motion vectors generated by the motion estimation block 320, in addition to the associated frames of the video stream, are passed to the back-end encoding blocks 330A-D. The back-end encoding blocks 330A-D may perform one or more back-end encoding steps to generate video streams 1, 2, 3, and 4 that are encoded based at least in part on the determined ABR profiles. Thus, the ABR server 110 only needs to perform motion estimation one time in order to generate multiple different encoded video streams for the content item, e.g. four different encoded streams in FIG. 3.

The ABR server 110 may segment the encoded video streams, e.g. into segments of 2-10 seconds duration on a presentation timeline, and may advertise the segments of the encoded streams to the electronic devices 102, 104, 106. The ABR server 110 may provide segments of the encoded video streams to the electronic devices 102, 104, 106 in response to requests therefor.

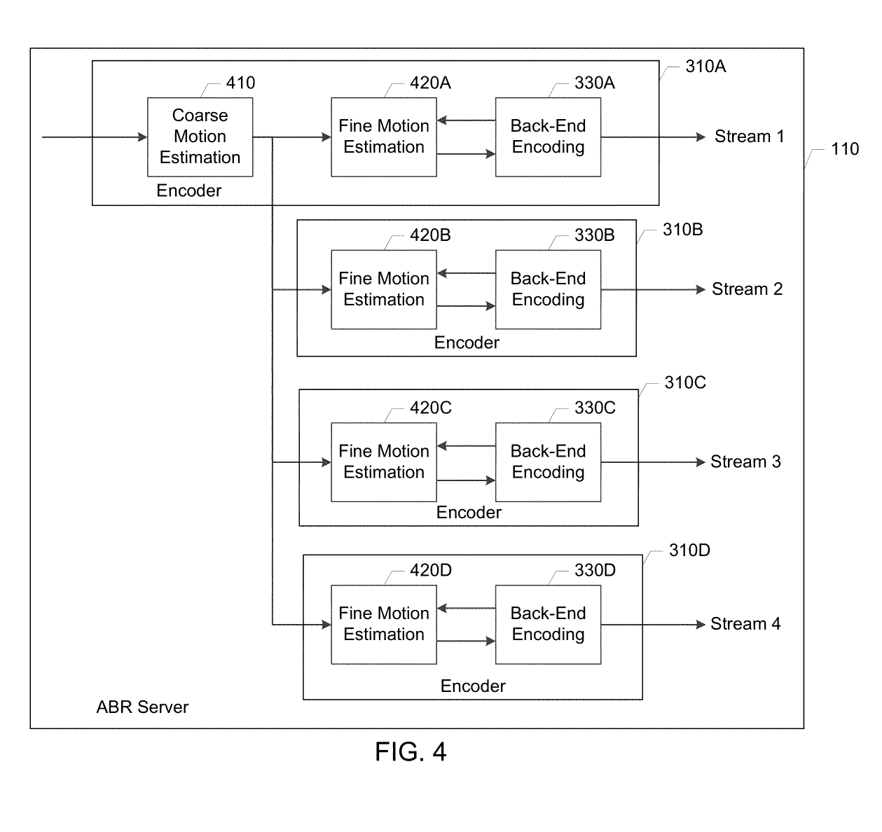

FIG. 4 illustrates an example adaptive bit rate (ABR) server 110 that may implement motion vector reuse for adaptive bit rate streaming in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The ABR server 110 includes encoders 310A-D that separate motion estimation into multiple layers, e.g. a coarse motion estimation stage and a fine motion estimation stage. The encoder 310A includes a coarse motion estimation block 410 for performing the coarse motion estimation and for generating coarse motion estimation vectors. The encoders 310A-D include fine motion estimation blocks 420A-D that are configured to refine the motion vectors generated by the coarse motion estimation block 410, e.g. based on the configured encoding characteristics of the encoders 310A-D. Thus, the fine motion estimation blocks 420A-D may select the vectors that are more efficient for a particular sequence of the video stream, e.g. based on the configured encoding characteristics of the encoders 310A-D. The encoders 310A-D further include the back-end encoding blocks 330A-D for performing any back-end encoding steps of the encoding process and generating the encoded streams 1-4.

The coarse motion estimation block 410 may be, or may include, suitable logic, circuitry, interfaces, memory, processors, and/or code that enables coarse motion estimation for a video stream. The fine motion estimation blocks 420A-D may be, or may include, suitable logic, circuitry, interfaces, memory, processors, and/or code that enables fine motion estimation for a video stream.

In one or more implementations, the coarse motion estimation block 410 may initially search a wide range of pixels to generate coarse motion vectors that provide a coarse estimate of the motion. The fine motion estimation blocks 420A-D may search in a small region around the coarse motion vectors to refine the initial estimate of the motion. For example, the coarse motion estimation block 410 might find motion vectors of full-pixel accuracy, while the fine motion estimation blocks 420A-D may refine those motion vectors to half- or quarter-pixel accuracy. In one or more implementations, the encoders 310A-D may separate the motion estimation process into more than two stages, e.g. three stages, four stages, etc. The motion vectors generated by any of the stages by any of the encoders 310A-D may be shared with the other encoders 310A-D.

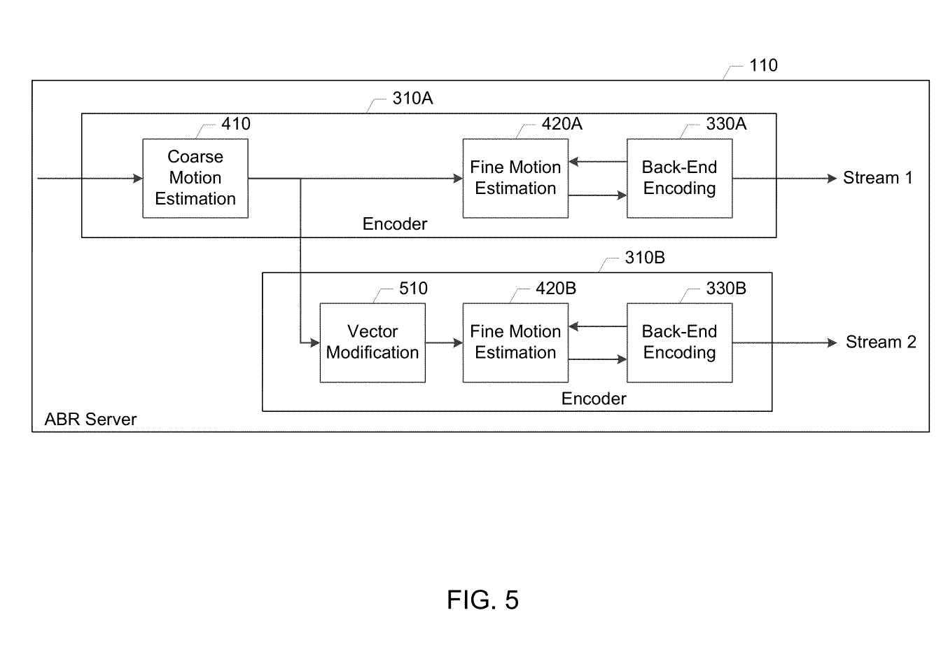

FIG. 5 illustrates an example adaptive bit rate (ABR) server 110 that may implement motion vector reuse for adaptive bit rate streaming in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The ABR server 110 includes encoders 310A-B that are configured to encode a video stream based on determined ABR profiles to generate encoded versions of the video stream, e.g. streams 1 and 2. The encoder 310A includes a coarse motion estimation block 410, and the encoders 310A-B include the fine motion estimation blocks 420A-B and the back-end encoding blocks 330A-B that are configured to operate in at least the manner previously discussed with respect to FIGS. 3 and 4. The encoder 310B further includes a vector modification block 510 that modifies the motion vectors generated by the coarse motion estimation block 410 of the encoder 310A, e.g. so that they are suitable for encoding the video stream based on the configured encoding characteristics of the encoder 310B. The vector modification block 510 may be, or may include, suitable logic, circuitry, interfaces, memory, processors, and/or code that enables modifying motion vectors.

Since the encoders 310A-B may be configured with different encoding characteristics, e.g. different resolutions, frame rates, codecs, qualities, etc., to generate different bit rate versions of the video stream, the motion vectors selected for the encoding of the video stream being performed by the encoder 310A may not be directly applicable to the encoding of the video stream being performed by the encoder 310B. Thus, the vector modification block 510 of the encoder 310B modifies the motion vectors selected by the encoder 310A so that they are suitable for the encoding of the video stream being performed by the encoder 310B.

In one or more implementations, the vector modification block 510 may spatially scale the motion vectors generated by the coarse motion estimation block 410, e.g., when the motion vectors selected for the resolution being encoded by the encoder 310A cannot be directly applied to encoding the video stream at the resolution at which the encoder 310B is encoding the video stream. For example, motion vectors selected for encoding the video stream at a high-definition (HD) resolution may be too large to be used for encoding the video stream at a standard-definition (SD) resolution. Thus, the motion vectors may need to be scaled proportionally to the change in resolution. An example of spatial motion vector scaling is discussed further below with respect to FIG. 8.

In one or more implementations, the vector modification block 510 may temporally scale the motion vectors generated by the coarse motion estimation block 410, e.g., when the selected motion vectors cannot be used by the encoder 310B because they point to reference frames that are not available for the encoder 310B. For example, if the encoder 310A is encoding the video stream at 60 frames per second, and the encoder 310B is encoding the video stream at 30 frames per second, the selected motion vectors may point to a reference frame that does not exist in the 30 frames per second version of the video stream. Thus, the vector modification block 510 may need to scale up the selected motion vector proportionally to the temporal distance between the reference frame pointed to by the motion vectors generated by the encoder 310A and a reference frame that is available in the video stream being encoded by the encoder 310B, e.g. by a factor of 2 when the encoder 310A is encoding at 60 frames per second and the encoder 310B is encoding at 30 frames per second. A similar modification may need to be performed when the encoder 310A is encoding with a codec that allows for multiple reference frames and the encoder 310B is encoding with a codec that only allows one reference frame. An example of temporal motion vector scaling is discussed further below with respect to FIG. 9.

In one or more implementations, the vector modification block 510 may aggregate multiple motion vectors generated by the coarse motion estimation block 410, e.g. when the selected motion vectors correspond to a region that is too small to be used for the sequence of the video stream being encoded by the encoder 310B. For example, different codecs may utilize different vector sizes, some of which may be too small to use in other codecs. Thus, the vector modification block 510 may combine together smaller motion vectors, e.g. average vector, median vector, to be used as over a larger region. Alternatively, or in addition, the encoder 310B may use a set of smaller motion vectors from the coarse motion estimation block 410 as multiple candidates for the fine motion estimation block 420B. An example of aggregating motion vectors is discussed further below with respect to FIG. 10.

In one or more implementations, if the motion vectors generated by the coarse motion estimation block 410 are too large to be used by the encoder 310B, the vector modification block 510 may duplicate the motion vectors for use in smaller regions. For example, a 64×64 vector generated by the coarse motion estimation block 410 for the High Efficiency Video Coding (HEVC) codec could be duplicated for use in the corresponding 16×16 macroblock positions of an MPEG-2 sequence being encoded by the encoder 310B.

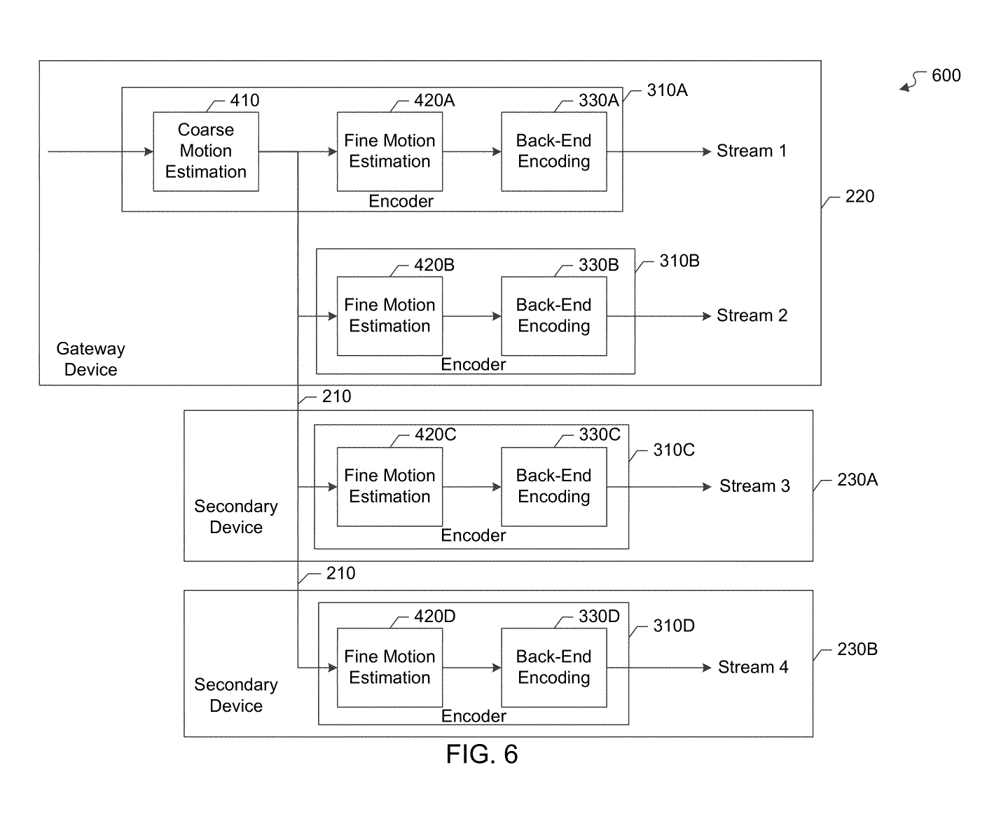

FIG. 6 illustrates an example network environment 600 in which motion vector reuse for adaptive bit rate streaming may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 600 includes the gateway device 220, the secondary devices 230A-B and the transmission network 210 that couples the gateway device 220 to the secondary devices 230A-B. The gateway device 220 includes the encoders 310A-B, the secondary device 230A includes the encoder 310C, and the secondary device 230B includes the encoder 310D. The encoder 310A includes the coarse motion estimation block 410 and the encoders 310A-D include the fine motion estimation blocks 420A-D and the back-end encoding blocks 330A-D.

In operation, the encoders 310A-D operate as discussed above with respect to FIG. 4, i.e. the coarse motion estimation block 410 generates coarse motion vectors that are used by each of the encoders 310A-D to encode the video stream. However, the encoders 310A-D are distributed across multiple devices 220, 230A-B of the network environment 600. Thus, the coarse motion vectors generated by the coarse motion estimation block 410 of the gateway device 220 are distributed to the secondary devices 230A-B. The coarse motion vectors are distributed to the secondary devices 230A-B such that the encoders 310C-D of the secondary devices 230A-B can determine the location and size of each motion vector and can synchronize the motion vector information with the correct frame in the original sequence of the video stream. For example, the gateway device 220 may convert a generated motion vector, the reference frame(s), the size, and position into a bitstream that is suitable for transmission within the video stream to the secondary devices 230A-B. In one or more implementations, the gateway device 220 may also compress the motion vector information, e.g. using entropy coding, etc.

In one or more implementations, in order to transmit the bitstream within the video stream, the vector data corresponding to each frame can be inserted into the original video stream as picture level user data, e.g. supplemental enhancement information (SEI) of the High Efficiency Video Coding (HEVC) and/or H.264/MPEG-4 Advanced Video Coding (AVC) codecs. In one or more implementations, e.g. when using MPEG-2 transport streams, the motion vector information can be packetized separately and carried on its own packet identifier (PID) with timestamps for synchronization. For example, a frame of motion vector data could be inserted into an MPEG-2 packetized elementary stream (PES) packet with presentation time stamp (PTS) values that match the corresponding PTS values of the original video frames. The vector data packets could be inserted into the existing transport stream on their own PID.

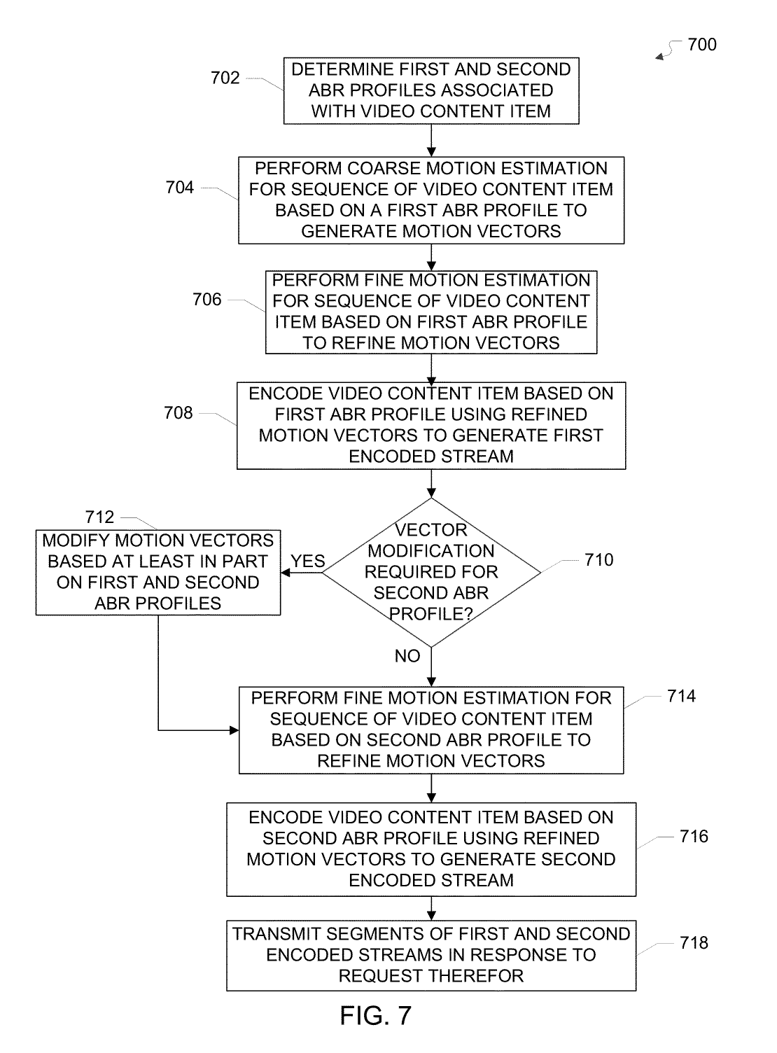

FIG. 7 illustrates a flow diagram of an example process 700 of motion vector reuse for adaptive bit rate streaming in accordance with one or more implementations. For explanatory purposes, the example process 700 is described herein with reference to the ABR server 110 of FIGS. 1-5; however, the example process 700 is not limited to the ABR server 110, and the example process 700 may be performed by one or more components of the ABR server 110, such as host processors, encoders, etc. For example, the example process 700 may also be performed by the gateway device 220 alone or in conjunction with one or more of the secondary devices 230A-B. Further for explanatory purposes, the blocks of the example process 700 are described herein as occurring in serial, or linearly. However, multiple blocks of the example process 700 may occur in parallel. In addition, the blocks of the example process 700 need not be performed in the order shown and/or one or more of the blocks of the example process 700 need not be performed.

The ABR server 110 determines first and second ABR profiles that are associated with a video content item (702). For example, the ABR server 110 may determine ABR profiles that are likely to be requested by one or more of the electronic devices 102, 104, 106, e.g. based on determinable network conditions and/or based on ABR profiles presently being accessed by one or more of the electronic devices 102, 104, 106.

The ABR server 110, e.g. via the coarse motion estimation block 410 of the encoder 310A, performs coarse motion estimation for encoding a sequence of frames of the video content item based on the first ABR profile to generate motion vectors (704). The ABR server 110, e.g. via the fine motion estimation block 420A of the encoder 310A, performs fine motion estimation on the sequence of the video content item to refine the generated motion vectors based on encoding characteristics of the first ABR profile (706). The ABR server 110, e.g. via the back-end encoding block 330A of the encoder 310A, encodes the video content item based on the first ABR profile using the refined motion vectors generated by the fine motion estimation block 420A to generate a first encoded stream (708).

The ABR server 110 determines whether vector modification is required for encoding the video content item based on the second ABR profile using the motion vectors generated for encoding the first ABR profile (710). For example, the ABR server 110 may determine whether the encoding characteristics of the ABR profiles have different resolutions, different frame rates, use different codecs, etc. If the ABR server 110 determines that vector modification is required (710), the ABR server 110, e.g. via the vector modification block 510, modifies the motion vectors based at least in part on the encoding characteristics of the first and second ABR profiles (712). For example, the ABR server 110 may temporally scale the motion vectors, may spatially scale the motion vectors, may aggregate motion vectors, may duplicate motion vectors, or any combination thereof.

The ABR server 110, e.g. via the fine motion estimation block 420B of the encoder 310B, performs fine motion estimation on the sequence of the video content item to refine the generated (and possibly modified) motion vectors based on encoding characteristics of the second ABR profile (714). The ABR server 110, e.g. via the back-end encoding block 330B of the encoder 310B, encodes the video content item based on the second ABR profile using the refined motion vectors generated by the fine motion estimation block 420B to generate a second encoded stream (716). The ABR server 110 may segment the first and second encoded streams and may advertise, e.g. via a manifest file, the available segments of the first and second encoded streams to the electronic devices 102, 104, 106. The ABR server 110 transmits segments of the first and second encoded streams in response to requests therefor (718), e.g. requests from the electronic devices 102, 104, 106.

FIG. 8 illustrates spatial motion vector scaling for motion vector reuse in accordance with one or more implementations. In FIG. 8, the motion vectors 820A may have been generated from a high definition (HD) frame 810A of a video stream and may be too large to be used for encoding a standard definition (SD) frame 810B of the video stream. Thus, the motion vectors 820A may be spatially scaled proportionally to the change in resolution to generate smaller motion vectors 820B that may be used to encode the SD frame 810B of the video stream.

FIG. 9 illustrates temporal motion vector scaling for motion vector reuse in accordance with one or more implementations. In FIG. 9, a first region 905A of a frame 910 is associated with a first motion vector 910A that uses a first reference frame 920A for prediction and a second region 905B of the frame 910 is associated with a second motion vector 910B that uses a second reference frame 920B for prediction. For example, the frame 910 may be encoded using HEVC or AVC, which may allow the use of multiple reference frames 920A-B for prediction. However, other codecs, such as MPEG-2, may only allow the use of the first reference frame 920A for prediction. Thus, only the motion vector 910A may be reused for MPEG-2 without performing vector modification. However, the second motion vector 910B may be reused for MPEG-2 if the second motion vector 910B is scaled down, e.g. by a factor of ½, to account for the shorter temporal distance between the frame 910 and the second reference frame 920A as opposed to the frame 910 and the reference frame 920B. Similarly, as previously discussed, the first reference frame 920A may not be available if the sequence is being encoded at a slower frame rate, e.g. 30 frames per second versus 60 frames per second. Thus, in this instance the motion vector 910A may not be reusable without performing vector modification, e.g. scaling up by a factor of 2, to match the longer temporal distance at 30 frames per second.

FIG. 10 illustrates motion vector aggregation for motion vector reuse in accordance with one or more implementations. In FIG. 10, the regions 1010A-D may each be associated with a motion vector 1015A-D. However, the motion vectors 1015A-D may not be reusable for a larger region 1020 without vector modification. For example, an 8×8 motion vector from an AVC encoder could not be used directly by an MPEG-2 encoder since MPEG-2 only supports 16×16 motion vectors. Similarly, if an HD vector was scaled down due to a change in resolution, the HD vector may correspond to a region that is now too small for an SD encoder to use.

Thus, the encoder 310B that is encoding the region 1020 may combine the vectors 1015A-D, e.g. the average vector, the median vector, or generally any vector aggregation, to generate the motion vector 1025 for encoding the larger region 1020. Alternatively, or in addition, the motion vectors 1015A-D may be used as multiple candidates for a fine motion vector refinement stage for encoding the larger region 1020.

FIG. 11 conceptually illustrates an electronic system 1100 with which one or more implementations of the subject technology may be implemented. The electronic system 1100, for example, can be a desktop computer, a laptop computer, a tablet computer, a server, a switch, a router, a base station, a receiver, a phone, a personal digital assistant (PDA), or generally any electronic device that transmits signals over a network. The electronic system 1100 may be, and/or may include one or more components of, one or more of the ABR server 110, the electronic devices 102, 104, 106, the gateway device 220, and/or the secondary devices 230A-B. Such an electronic system 1100 includes various types of computer readable media and interfaces for various other types of computer readable media. The electronic system 1100 includes a bus 1108, one or more processing unit(s) 1112, a system memory 1104, a read-only memory (ROM) 1110, a permanent storage device 1102, an input device interface 1114, an output device interface 1106, one or more network interfaces 1116, such as local area network (LAN) interfaces and/or wide area network interfaces (WAN), or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to a network (not shown) through one or more network interfaces 1116, such as one or more LAN interfaces and/or WAN interfaces. In this manner, the electronic system 1100 can be a part of a network of computers, such as a LAN, a WAN, an Intranet, or a network of networks, such as the Internet. Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A content distribution device comprising:
a first encoder that is configured to perform motion estimation on a video content item to generate motion vectors for the video content item, and to encode the video content item using the motion vectors and based at least in part on a first adaptive bit rate (ABR) profile to generate a first encoded stream;
a second encoder that is configured to encode the video content item using the motion vectors generated by the first encoder and based at least in part on a second ABR profile to generate a second encoded stream; and
a network interface that is configured to initiate transmission of segments of the first and second encoded streams in response to requests therefor.

2. The content distribution device of claim 1, wherein the first encoder comprises a coarse motion estimation block that is configured to generate the motion vectors and the first encoder comprises a first fine motion estimation block that is configured to refine the motion vectors based at least in part on the first ABR profile, wherein the refined motion vectors are used to encode the video content item to generate the first encoded stream.

3. The content distribution device of claim 2, wherein the second encoder comprises a second fine motion estimation block that is configured to refine the motion vectors generated by the first encoder based at least in part on the second ABR profile, wherein the refined motion vectors are used to encode the video content item to generate the second encoded stream.

4. The content distribution device of claim 1, wherein the first and second ABR profiles each indicate at least one of a bit rate, a resolution, a frame rate, or a codec.

5. The content distribution device of claim 4, further comprising a vector modification block that is configured to modify the motion vectors to generate modified motion vectors, wherein the modified motion vectors are used to generate the second encoded stream.

6. The content distribution device of claim 5, wherein the vector modification block is further configured to spatially scale the motion vectors based at least in part on a difference in a first resolution indicated in the first ABR profile and a second resolution indicated in the second ABR profile.

7. The content distribution device of claim 5, wherein the vector modification block is further configured to temporally scale the motion vectors when the motion vectors point to at least one reference frame that is not available to the second encoder.

8. The content distribution device of claim 5, wherein the vector modification block is further configured to aggregate the motion vectors or duplicate the motion vectors based at least in part on a difference between first motion vector sizes associated with a first codec indicated in the first ABR profile and second motion vector sizes associated with a second codec indicated in the second ABR profile.

9. A method for reusing motion vectors across distributed devices, the method comprising:
determining a first adaptive bit rate (ABR) profile and a second ABR profile associated with a video content item;
performing motion estimation on the video content item to generate motion vectors for the video content item;
encoding the video content item using the motion vectors and based at least in part on the first ABR profile to generate a first encoded stream;
initiating transmission of information describing the motion vectors and the video content item to a secondary device, wherein the secondary device encodes the video content item using the information describing the motion vectors and based at least in part on the second ABR profile; and
transmitting first segments of the first encoded stream in response to requests therefor.

10. The method of claim 9, further comprising:
receiving second segments of the second encoded stream from the secondary device; and
transmitting second segments of the second encoded stream in response to requests therefor.

11. The method of claim 9, wherein the secondary device transmits second segments of the second encoded stream in response to requests therefor.

12. The method of claim 9, further comprising:
retrieving, from an adaptive bit rate server, original segments of the video content item.

13. The method of claim 9, wherein initiating the transmission of the information describing the motion vectors and the video content item to the secondary device comprises:
inserting the information describing the motion vectors into the video content item as picture level user data; and
initiating the transmission of the video content item with the inserted information describing the motion vectors to the secondary device.

14. The method of claim 9, wherein initiating the transmission of the information describing the motion vectors and the video content item to the secondary device comprises:
packetizing the information describing the motion vectors to generate motion vector packets, wherein the motion vector packets include a timestamp that matches a sequence of the video content item that corresponds to the motion vectors; and
initiating the transmission of the video content item with the motion vector packets to the secondary device.

15. A computer program product comprising instructions stored in a tangible computer-readable storage medium, the instructions comprising:
instructions for determining a first adaptive bit rate (ABR) profile and a second ABR profile associated with a video content item;
instructions for performing motion estimation on the video content item to generate motion vectors for the video content item;
instructions for encoding the video content item using the motion vectors and based at least in part on the first ABR profile to generate a first encoded stream;
instructions for modifying the motion vectors to generate modified motion vectors;
instructions for encoding the video content item using the modified motion vectors and based at least in part on the second ABR profile to generate a second encoded stream; and
transmitting segments of the first and second encoded streams in response to requests therefor.

16. The computer program product of claim 15, wherein the first and second ABR profiles each indicate at least one of a bit rate, a resolution, a frame rate, or a codec.

17. The computer program product of claim 16, wherein the instructions for modifying the motion vectors to generate the modified motion vectors comprise:
instructions for spatially scaling the motion vectors based at least in part on a difference in a first resolution indicated in the first ABR profile and a second resolution indicated in the second ABR profile.

18. The computer program product of claim 16, wherein the instructions for modifying the motion vectors to generate the modified motion vectors comprise:
instructions for temporally scaling the motion vectors based at least in part on a difference in a first frame rate indicated in the first ABR profile and a second frame rate indicated in the second ABR profile.

19. The computer program product of claim 16, wherein the instructions for modifying the motion vectors to generate the modified motion vectors comprise:
instructions for aggregating the motion vectors or duplicating the motion vectors based at least in part on a difference between first motion vector sizes associated with a first codec indicated in the first ABR profile and second motion vector sizes associated with a second codec indicated in the second ABR profile.

20. The computer program product of claim 15, wherein the instructions for encoding the video content item based at least in part on the first ABR profile and using the motion vectors to generate the first encoded stream further comprise:
instructions for performing fine motion estimation on the video content item based at least in part on the motion vectors to refine the motion vectors; and
instructions for encoding the video content item based at least in part on the first ABR profile and using the refined motion vectors to generate the first encoded stream.
